(19) United States
(12) Patent Application Publication
(10) Pub. No.: US 2005/0108047 A1
(43) Pub. Date: May 19, 2005

(54) Business methods for commercializing antibiotics

(75) Inventor: Nathaniel E. David, San Francisco, CA (US)

Correspondence Address: WILSON SONSINI GOODRICH & ROSATI, 650 PAGE MILL ROAD, PALO ALTO, CA, 943041050, US

(73) Assignee: VVII NewCo 2003, Inc.

(21) Appl. No.: 10/718,499

(22) Filed: Nov. 19, 2003

(51) Int. Cl. G06F 17/60

(52) U.S. Cl. 705/2

(57) ABSTRACT

Business methods for commercialization of antibiotics are disclosed. According to one embodiment of the invention, drugs that are found to be otherwise effective and safe, but which are not acceptable due to rapid development of resistance, are rescued by way of the use of achaogens. A biopharmaceutical company may then, for example, charge royalties or purchase such drugs for its own account.

### BACKGROUND

The worldwide emergence of bacteria that are resistant to available antibiotics threatens to undo the dramatic advances in human health witnessed in the second half of the last century. This development is especially troubling considering that only one new class of antibiotics (the oxazolidinones) has been introduced in the past 35 years.

The healthcare establishment is countering the ever-increasing prevalence of antibiotic resistant bacteria with two major tactics: (1) by trying to invent new antibiotics and (2) by limiting antibiotic use to extend drug utility. While in principle delaying the day in which modern medicine finds itself without drugs to fight bacterial infections, these approaches ignore the underlying mechanisms driving antibiotic resistance in the first place.

New business methods are needed to address the growing problem of antibiotic resistance.

### SUMMARY OF THE INVENTION

A business method is disclosed for commercializing antibiotics. In one embodiment, the invention includes the steps of identifying a compound that is effective as an antibiotic; determining if bacteria develop resistance to the compound whereby said compound would have decreased market potential because of, at least in part, said resistance; and selling said compound with an achaogen, i.e., an agent that inhibits the mutational process.

### BRIEF DESCRIPTION OF THE DRAWINGS

FIG. 1 depicts the cellular function of LexA under normal conditions and under the condition of cellular stress.

FIG. 2 depicts the ability of dipeptide boronic acid libraries to inhibit LexA proteolysis.

FIG. 3 depicts the ability of acetylated dipeptide boronic acids to inhibit LexA proteolysis.

FIG. 4 depicts the structures of tripeptide boronic acid inhibitors and their effects on LexA cleavage.

FIG. 5 depicts the structures of tripeptide boronic acid inhibitors.

FIG. 6 is a graphic depiction of the Stressful Lifestyle Adaptive Mutation (SLAM) assay.

FIG. 7 depicts mutation rates in the presence of ciprofloxacin for different bacterial strains.

### DETAILED DESCRIPTION OF INVENTION

The emergence of antibiotic resistant bacteria is an increasing threat to human health and to the financial health of businesses that discover, develop, market, and sell antibiotics. The inventions herein provide methods that enable increased business opportunities for the discovery, development, marketing, and sales of antibiotic compounds. Such business methods are useful for a wide range of applications, including the preclinical development of antibiotics, the clinical development of antibiotics, and the marketing and sales of existing antibiotics. Achaogens may also be used in businesses such as veterinary medicine, livestock production, and in industries dependent on fermentation and other growth processes, where it is desirable to reduce the time-dependent generation of genetic diversity of cells.

One useful application of the business methods herein can be applied to preclinical drug candidates. Many useful preclinical drug candidates fail prior to the initiation of human clinical trials because bacteria quickly evolve resistance during preclinical studies. For example, a company may discover (or otherwise acquire) an NCE (a New Chemical Entity) with good anti-microbial properties. The molecule may be broad-spectrum and have favorable DMPK (distribution, metabolism, pharmacokinetic) properties, but bacteria quickly develop resistance.

It has been estimated that the average cost to create a clinical candidate is $15 MM-$25 MM. As such, preclinical failures resulting from antibiotic resistance can cost as much as $25 MM per failure, which creates a significant burden for companies involved in preclinical antibiotic discovery. In addition, many antibiotic drugs are plagued by the emergence of resistance during the course of clinical development or even well into their lives as marketed drugs, creating an even greater financial burden for a company that pursues such compounds.

As described in U.S. Ser. No. ______, attorney docket number 29117-701, filed on the same day as the present invention, mutations that block the proteolysis of LexA (a regulator of the bacterial induced mutational response) can reduce the ability of E. coli to evolve clinical resistance to ciprofloxacin (Cipro) by six (6) to seven (7) orders of magnitude. Achaogens are drugs that would decrease the ability of cells to mutate and, as a result, reduce the ability of bacteria to become antibiotic resistant. Examples of such drugs include small molecule LexA proteolysis inhibitors. The present invention provides new business methods that utilize these and other achaogens in pharmaceutical and biotechnology companies, as well as other types of companies that discover, develop, market, or sell antibiotics.

In one embodiment of the invention described herein, an acquiring company licenses or otherwise acquires the rights to a preclinical antibiotic candidate(s) from an organization that, because of the rapid emergence of drug resistance against said candidate(s), might not pursue the candidate(s). In this embodiment of the invention, the candidate(s) are “rescued” as a result of the availability of an achaogen that might be utilized in combination with the candidate(s).

In this embodiment of the invention, the business arrangement between the acquiring company and the licensing organization may provide for the acquiring company to acquire intellectual property rights to such antibiotic drug candidates, along with, in some cases, associated technical information. The acquiring company would pay the licensing organization some combination of upfront fees, ongoing research and development payments, milestone payments (upon, for example, the acquiring company achieving clinical development, revenue creation, or technical success milestones) and other consideration. The payments may be in the form of, for example, cash, equity, or traded assets (including, for example, rights to other drug candidates).

In return, the organization owning the rights to the antibiotic candidates, in some embodiments, would grant exclusive or non-exclusive licenses to the intellectual property rights associated with the candidates, or assign the intellectual property rights associated with such candidates to the acquiring company. The rights may be granted in-toto or in specific fields or territories, such as in combination with specifically named achaogens, classes of achaogens, or achaogens to be developed. In some cases, the organization granting the rights to the candidates would retain rights to make, use, or sell the antibiotic in co-formulations not developed by the acquiring company.

In some cases, the organization granting the rights to the antibiotic would retain the right to market and/or co-market an achaogen co-formulation developed by the acquiring company in a particular geographic region (e.g., Asia). In other embodiments, the acquiring company might grant the licensing organization a time-limited buy-back option to re-acquire rights to licensed antibiotic candidates, in some cases for use in association with the achaogen, such as for use in a combination therapy. In such situations, the acquiring company may receive higher royalty rates, milestones and other fees in return for having moved the candidate(s) closer to commercialization in combination with an achaogen.

The acquiring company may grant the rights back subject to, for example, retained geographic marketing rights, and may retain the right to manufacture/supply the achaogen for use with the antibiotic. For example, the acquiring company may retain the right to manufacture and provide to the company exercising it buy-back right an achaogen in those situations where the licensing organization exercises a buy back right or a right to sell in a particular territory.

In alternative embodiments, the company holding the rights to the preclinical candidates (or other compounds) collaborates with a company holding rights to an achaogen, and/or licenses rights to use the achaogen in combination with one or more of its antibiotic drugs. In this case, the company holding the rights to the antibiotic compounds retains its intellectual property rights, but may provide compensation to the achaogen provider in the form of, for example, research funding, milestones, and/or royalties on the antibiotic/achaogen combination. The company holding rights to the achaogen may retain the right to manufacture the achaogen, or there may be a mix of all the above rights such as where, for example, the company holding rights to the achaogen obtains jurisdictional marketing rights to the underlying antibiotic.

The above methods may also be applied to compounds that have already proceeded into clinical development, but which have failed in clinical trials. Many otherwise useful antibiotics fail during human clinical trials because bacteria evolve resistance (peptide deformylase inhibitors are such examples). See Apfel C, Banner D W, Bur D, Dietz M, Hirata T, Hubschwerlen C, Locher H, Page M G, Pirson W, Rosse G, Specklin J L. Hydroxamic acid derivatives as potent peptide deformylase inhibitors and antibacterial agents. J Med Chem. 2000 Jun. 15; 43(12):2324-31.). Recently published industry averages now suggest that the cost to conduct a complete set of antibiotic clinical trials is in excess of $40 MM US. As such, clinical failures resulting from antibiotic resistance can cost, it is estimated, as much as $40 MM per failure, which is one of the multiple reasons many pharmaceutical companies are abandoning antibiotic research and development. Note that this $40 MM estimate ignores all costs prior to the initiation of human clinical trials. It is estimated, therefore, that the actual loss resulting from clinical failure is likely to be in excess of $65 MM US (i.e., preclinical costs+clinical costs). Accordingly, some or all of the arrangements discussed above may also be used in association with an antibiotic that has failed in clinical trials.

There are also business threats to the sales of antibiotic compounds that are already on the market due to (1) the emergence of drug resistance, and (2) patent expiration. The use of achaogen co-therapy has the capacity to counter both of these business threats. Because antibiotic use ultimately engenders resistance, an antibiotic's effectiveness and sales drop over time. If sales of a large antibiotic drug product are dramatically reduced because of resistance, large pharmaceutical companies may lose sales. Similarly, sales of a popular antibiotic drug product often drop when the patent on such drug expires. Cipro had worldwide sales of $1.7 billion in 2002 and its patent expires in December 2003. When this occurs, it is likely that Bayer will experience a decrease in annual revenue in excess of $ 1 billion.

Even in those cases where a drug is potent, broad-spectrum, and selling more than $1 billion US each year, the use of the drug (which drives its sales) gradually decreases the drug's clinical efficacy (nearly one third of certain new bacterial infections are Cipro, Zithromax, or Biaxin resistant). Knowledgeable physicians, because they are aware of this trend, are reluctant to prescribe certain drugs except when absolutely necessary. This results in fewer prescriptions for a given antibiotic, undermining the profitability of a given franchise.

Therefore, in another embodiment of the invention, a company with rights to achaogen technology enters into business arrangements with a company that has an antibiotic compound franchise that is beginning to suffer the financial effects of emerging bacterial resistance or patent expiration. In this embodiment of the invention, the company holding the rights to achaogen technology would collaborate to develop and/or commercialize achaogens with the antibiotic, potentially slowing the development of resistance to the antibiotic in question. And, because the co-formulation (or co-administration) with the achaogen may represent a newly patented composition (or method), two threats to the drug franchise may be simultaneously addressed—antibiotic resistance is significantly slowed and patent positioning (through combination patents) is significantly improved. In these embodiments, some or all of the same financial arrangements used in the drug rescue embodiment may be employed. For example, the achaogen provider may license the rights to the achaogen to the company marketing the antibiotic, or may supply and/or co-market the achaogen with the antibiotic. In some cases, the company holding the rights to the achaogen may receive license fees, research funding, milestone payments, and/or up front payments, as well as, for example, territorial marketing rights to the antibiotic.

In yet another embodiment of the invention, a company holding rights to achaogen technology would ‘rescue’ off-patent antibiotics that have been abandoned (or are showing reduced sales) due to the emergence of drug resistance. Some of these older drugs (e.g., streptomycin, rifampicin, nalidxic acid, novobiocin, trimethoprim, etc.) could be clinically useful today, were it not for the rapid emergence of drug resistance against them. By co-formulating or co-administering or otherwise using an achaogen in combination with these older, infrequently used, or off-patent drugs with achaogens, a company creates new, efficacious, patented antibiotic therapies via achaogen co-therapy. Valuable patent rights to the combination therapies could be obtained in some cases, and the combination therapy rights could be licensed in the manner set forth above. In some embodiments, a company progresses its achaogen-off patent antibiotic co-formulation through human clinical trials and then enters into a business agreement with some or all of the features set forth above. In yet another embodiment of this invention, a company does not partner its achaogen-off patent antibiotic co-formulation. In this embodiment, a company maintains its ownership of the asset, progresses the co-formulation through human clinical trials, and then launches the co-formulation as a proprietary product.

To determine which drug compounds represent the most strategic partnering opportunities, some embodiments of the invention provide for profiling of antibiotics for their market size, date of patent expiration, and the susceptibility of their mechanism of antibiotic resistance to achaogen co-therapy. An ideal partnering opportunity would meet the following criteria: the antibiotic would already have large market share today (e.g., Levaquin, Zithromax) or is anticipated to have a large market share at the projected time of the first achaogen FDA approval (e.g., Tequin, Zyvox); the mechanism of resistance against the antibiotic can be inhibited with an achaogen (e.g., mutation plays a role in the emergence of resistance to fluoroquinolones, oxazolidinones, rifamycins, and partially to macrolides); the date of patent expiration for the antibiotic is beyond some particular date, e.g. 2012 or later. Representative compounds for which a franchise may be extended according to the methods herein are represented in Table 1.

TABLE 1
Summary of data on franchise extension opportunities.

| | | | | PROJECTED | |
|---|---|---|---|---|---|
| | | | | ‘WORST | |
| | | FREQUENCY of | | STRAIN’ | PROJECTED |
| | | SPONTANEOUS | | RESISTANCE | MARKET |
| DRUG | COMPANY | RESISTANCE | INDICATIONS | (2012)* | (2012)** |
| LEVAQUIN | Ortho McNeil | 1 × 10⁻⁹-1 × 10⁻¹⁰ | Acute maxillary | 32% | $100-$200 |
| Launched: 1996 | | | sinusitis, chronic | 16 years post | million (due to |
| | | | bronchitis, community | launch | generic |
| | | | acquired pneumonia, | | competition) |
| | | | skin infections, UTIs, | | |
| | | | acute pyelonephritis | | |
| AVELOX | Bayer | 1.8 × 10⁻⁹-1 × 10⁻¹¹ | Chronic bronchitis, | 5%-26% | $100-$500 |
| moxifloxacin | | note: 4^{rd} generation | community acquired | dual site | million |
| Launched: 1999 | | fluoroquinolone dual | pneumonia, skin | inhibition | (can prolong QT |
| | | action suppresses | infection | mechanism | interval) |
| | | resistance. Unique 8- | | 13 years post | |
| | | methoxy structure | | launch | |
| TEQUIN | BMS | 1 × 10⁻⁷-1 × 10⁻¹⁰ | Chronic bronchitis, | 5%-24% | >$2 billion |
| gatifloxacin | | note: : 4^{rd} generation | Acute sinusitis, | dual site | |
| Launched: 2000 | | fluoroquinolone dual | community acquired | inhibition | |
| | | action suppresses | pneumonia, UTIs, | mechanism | |
| | | resistance. Unique 8- | gonorrhea (cervical, | 12 year post | |
| | | methoxy structure | urethral, rectal) | launch | |
| ZYVOX | Pfizer | 1 × 10⁻⁹- 1 × 10⁻¹¹ | Nosocomial pneumonia, | 24% | >$2 billion |
| linezolid | | | skin infections, | 12 years post | |
| Launched: 2000 | | | community acquired | launch | |
| | | | pneumonia, VRE | note this is a | |
| | | | infections | new class and | |
| | | | | thus may not | |
| | | | | follow past | |
| | | | | trends | |
| FACTIVE | Genesoft | n/a | MDR pneumonia | 18% | $1-$2 billion |
| gemifloxacin | | | | 9 years post | |
| Launched: 2003 | | | | launch | |
| KETEK | Aventis | n/a | penicillin- and | 5%-23.4% | >$1-2 billion |
| Launched: 2003 | | | macrolide-resistant S. pneumoniae | (dual site | |
| | | | infections | inhibition | |
| | | | in community acquired | mechanism) | |
| | | | pneumonia and acute | 9 years post | |
| | | | sinusitis | launch | |
| DESQUINOLONE | BMS | n/a | Chronic bronchitis, | 14% | ? |
| Launch: 2005 (?) | | | Acute sinusitis | 7 years post | |
| | | | | launch | |
| *This approximation was made by extrapolating from the current prevalence of specific bacterial strains resistant to Cipro, Zithromax, and Biaxin. If one assumes their product launch dates (1987, 1991, and 1991 respectively) as the date at which the selection of resistant strains began, one can estimate the annual increase in resistance as follows: divide the current resistance prevalence by the number of years since launch to estimate the increase in resistance per year (which | | | | | |
| # is 2%, and 2.6%, and 2.6% respectively). Note that these numbers represent a particularly alarming example strain, rather than describing the overall clinical effectiveness of the drug against many strains. So in principle, Levaquin (while predicted to have the worst resistance on the above table), would still be equal to Cipro's current utility today. This extrapolation, if correct, predicts that all of the drugs above will remain sufficiently clinically effective to warrant | | | | | |
| # franchise extension. Note that this estimate treats the rate of resistance to 4^{th} generation fluoroquinolones (i.e., Tequin and Avelox) as identical to 2^{nd} generation fluoroquinolones (e.g., Cipro). As such, the estimates above (while still warranting franchise extension in every case) depict a worst case scenario of resistance prevalence. | | | | | |

**These estimates were made (1) using 2002 sales of blockbuster antibiotics as comparables for the predicted blockbusters on the table and (2) using the estimated doubling of the antibiotic market by 2010 to $44 billion as a multiplier (e.g., a $1 billion dollar 2003 comparable drug was projected to be a $2 billion dollar drug in 2012).

Some achaogen co-formulations with antibiotics (e.g., co-formulations with Avelox, Tequin, Factive, Ketek, Levaquin, Desquinolone, Cipro, Biaxin, etc.) are best suited for the treatment of community infections (e.g., UTI's, gonorrhea, strep throat, etc.). In the case where a company owning an achaogen “rescues” a community antibiotic but does not develop its own community-focused sales force, it may partner its “rescued” community antibiotic(s) with large pharmaceutical companies. Large pharmaceutical companies maintain large community-focused sales forces (composed of thousands of salespeople) to sell into the general practitioner market throughout the US and Europe. Because accessing the hospital market, however, only requires a relatively small sales force (75-100 salespeople), a company owning an antibiotic-achaogen co-formulation may in certain cases prefer to retain the rights for its own marketing (or co-marketing) to “rescued” antibiotics best suited for the treatment of hospital infections, such as Methicillin-resistant Staph aureus (MRSA), Vancomycin-resistant enterococcus (VRE), or multi-drug resistant pneumonia. Such antibiotics include rifampicin (rifampin), streptomycin, novobiocin, gentamicin, tobramycyin, and spectinomycin.

The importance of addressing the problem of bacterial resistance is not unique to human therapeutics. For example, food-producing animals are given antibiotic drugs for therapeutic, prophylactic, or production applications. However, these drugs can cause microbes to become resistant to those drugs, or to drugs used to treat human illness, ultimately making some human sicknesses harder to treat. Moreover, even within animals, veterinarians have an increasingly restricted set of antibacterial agents available for their use due to increasing bacterial resistance. Any of the embodiments of the invention described herein could be applied to businesses with an interest in animal health.

Industrial applications of the achaogen technology may also be used in some embodiments. For example, a company holding the rights to an achaogen may license or supply the achaogen to an organization that relies upon bacteria or other organisms in manufacturing operations. Such operations may include protein manufacturing operations (such as therapeutic manufacturing) or industrial brewing.

Scientific Basis

Mutational Process and Drug Resistance

Specific genes that induce mutational processes in bacteria are described herein. These processes are in turn responsible for the development of certain types of antibiotic resistance. Bacterial strains in which these genes have been inactivated or modified can be used as tools to identify novel agents that inhibit the development of antibiotic resistance. Additionally, purified protein products encoded by these genes can be used for in vitro experiments to identify agents capable of inhibiting their biochemical activities. Thus, drugs may be developed that interfere with these genes or their gene products for the development of therapies that inhibit antibiotic resistance.

It is known that bacterial resistance to ciprofloxacin (a fluoroquinolone antibiotic) and perhaps to many synthetic antibiotics (such as rifampin and its derivatives, other fluoroquinolone derivatives, the oxazolidinones, etc.) results from multiple mutations in chromosomal genes. See Everett, M J, Jin, Y F, Ricci, V, Piddock, L J V: Contributions of individual mechanisms to fluoroquinolone resistance in 36 Escherichia coli strains isolated from humans and animals. Antimicrob Agents Chemother 1996, 40:2380-2386; Deguchi, T, Kawamura, T, Yasuda, M, Nakano, M, Fukuda, H, Kato, H, Kato, N, Okano, Y, Kawada, Y: In vivo selection of Klebsiella pneumoniae strains with enhanced quinolone resistance during fluoroquinolone treatment of urinary tract infections. Antimicrob Agents Chemother 1997, 41:1609-1611; Kanematsu, E, Deguchi, T, Yasuda, M, Kawamura, T, Nishino, Y, Kawada, Y: Alterations in the GyrA subunit of DNA gyrase and the ParC subunit of DNA topoisomerase IV associated with quinolone resistance in Enterococcus faecalis. Antimicrob Agents Chemother 1998, 42:433-435; and Wang, T, Tanaka, M, Sato, K: Detection of griA and gyrA mutations in 344 Staphylococcus aureus strains. Antimicrob Agents Chemother 1998, 42: 236-240.

Bacteria are able to control their own rate of mutation through the expression and modification of specific proteins dramatically increasing their rate of mutation by orders of magnitude when needed to hasten their own evolution. See Chicurel, M: Can organisms speed their own evolution? Science 2001, 292:1824-1827; Radman, M: Enzymes of evolutionary change. Nature 1999, 401:866-869; Friedberg, E C, Wagner, R, Radman, M: Specialized DNA polymerases, cellular survival, and the genesis of mutations. Science 2002, 296:1627-1630; and Taddei, F, Halliday, J A, Matic, I, Radman, M: Genetic analysis of mutagenesis in aging Escherichia coli colonies. Mol Gen Genet 1997, 256:277-281. The acquisition of certain mutations that confer antibiotic resistance is greatly facilitated by the activation of these mutagenesis pathway(s). Thus, it is proposed herein that methods and compositions that inhibit these mutagenesis pathway(s) represent a novel set of approaches to prevent antibiotic resistance by preventing mutations, particularly induced mutations.

Methods for Inhibiting Antibiotic Resistance

The biochemical pathway(s) that induce mutations are comprised of proteases, DNA binding proteins, helicases, and DNA polymerases. See Goodman, M F: Error-prone repair DNA polymerases in prokaryotes and eukaryotes. Annu Rev Biochem 2002, 71:17-50; Nickoloff, J A, Hoekstra, M F (eds.) DNA Damage and Repair (Humana Press, Totowa, N.J., 1998). Drugs that target such proteins would inhibit the development of mutations required for antibiotic resistance and thus dramatically enhance the utility of a wide range of antibiotics. In one embodiment of the present invention, achaogens are used to inhibit the development of antibiotic resistance. The term “achaogen” is used herein to mean an agent that inhibits the mutational process. That is, exposure of an organism to an achaogen results in a decrease in mutation frequency.

The inventors have used E. coli as a model bacterium to identify methods and compositions useful in the inhibition of induced mutagenesis and antibiotic resistance. Because many bacterial species contain functional analogs and/or direct structural homologs to these E. coli genes and gene products, the methods and compositions described herein will prove useful for inhibiting the development of antibiotic resistance in many bacterial species beyond E. coli, including, but not limited to, Corynebacterium diphtheriae, Streptococcus pyogenes, Streptobacillus moniliformis, Streptococcus agalactiae, Streptococcus pneumoniae, Salmonella typhi, Salmonella paratyphi, Salmonella schottmulleri, Salmonella hirshfeldii, Staphylococcus epidermidis, Staphylococcus aureus, Klebsiella pneumoniae, Mycoplasma pneumonia, Mycobacterium tuberculosis, Mycobacterium leprae, Yersinia enterocolitica, Yersinia pestis, Vibrio cholerae, Vibrio parahaemolyticus, Rickettsia prowazekii, Rickettsia rickettsii, Rickettsia akari, Clostridium difficile, Clostridium tetani, Clostridium perfringens, Clostridium novyii, Clostridium septicum, Clostridium botulinum, Legionella pneumophila, Hemophilus influenzae, Hemophilus parainfluenzae, Hemophilus aegyptus, Chlamydia psittaci, Chlamydia trachomatis, Bordetella pertusis, Shigella spp., Campylobacter jejuni, Proteus spp., Citrobacter spp., Enterobacter spp., Pseudomonas aeruginosa, Propionibacterium spp., Bacillus anthracis, Spirrilum minus, Neisseria meningitidis, Listeria monocytogenes, Neisseria gonorrheae, Treponema pallidum, Francisella tularensis, Brucella spp., Borrelia recurrentis, Borrelia hermsii, Borrelia turicatae, Borrelia burgdorferi, Mycobacterium avium, Mycobacterium smegmatis, methicillin-resistant Staphylococcus aureus, and Vancomycin-resistant enterococcus.

The methods and compositions described herein will prove useful for inhibiting the development of resistance to many antibiotics, including, but not limited to, Acrofloxacin, Amoxicillin plus clavulonic acid (i.e., Augmentin), Amikacin, Amplicillin, Apalcillin, Apramycin, Astromicin, Arbekacin, Aspoxicillin, Azidozillin, Azithromycin, Azlocillin, Bacitracin, Benzathine penicillin, Benzylpenicillin, Carbencillin, Cefaclor, Cefadroxil, Cefalexin, Cefamandole, Cefaparin, Cefatrizine, Cefazolin, Cefbuperazone, Cefcapene, Cefdinir, Cefditoren, Cefepime, Cefetamet, Cefixime, Cefinetazole, Cefininox, Cefoperazone, Ceforamide, Cefotaxime, Cefotetan, Cefotiam, Cefoxitin, Cefpimizole, Cefpiramide, Cefpodoxime, Cefprozil, Cefradine, Cefroxadine, Cefsulodin, Ceftazidime, Ceftriaxone, Cefuroxime, Chlorampenicol, Chlortetracycline, Ciclacillin, Cinoxacin, Ciprofloxacin, Clarithromycin, Clemizole penicillin, Clindamycin, Cloxacillin, Daptomycin, Demeclocycline, Desquinolone, Dibekacin, Dicloxacillin, Dirithromycin, Doxycycline, Enoxacin, Epicillin, Erthromycin, Ethambutol, Fleroxacin, Flomoxef, Flucloxacillin, Flumequine, Flurithromycin, Fosfomycin, Fosmidomycin, Fusidic acid, Gatifloxacin, Gemifloxaxin, Gentamicin, Imipenem, Imipenem plus Cilistatin combination, Isepamicin, Isoniazid, Josamycin, Kanamycin, Kasugamycin, Kitasamycin, Latamoxef, Levofloxacin, Lincomycin, Linezolid, Lomefloxacin, Loracarbaf, Lymecycline, Mecillinam, Meropenem, Methacycline, Methicillin, Metronidazole, Mezlocillin, Midecamycin, Minocycline, Miokamycin, Moxifloxacin, Nafcillin, Nafcillin, Nalidixic acid, Neomycin, Netilmicin, Norfloxacin, Novobiocin, Oflaxacin, Oleandomycin, Oxacillin, Oxolinic acid, Oxytetracycline, Paromycin, Pazufloxacin, Pefloxacin, Penicillin G, Penicillin V, Phenethicillin, Phenoxymethyl penicillin, Pipemidic acid, Piperacillin, Piperacillin and Tazobactam combination, Piromidic acid, Procaine penicillin, Propicillin, Pyrimethamine, Rifabutin, Rifamide, Rifampicin, Rifamycin SV, Rifapentene, Rokitamycin, Rolitetracycline, Roxithromycin, Rufloxacin, Sitafloxacin, Sparfloxacin, Spectinomycin, Spiramycin, Sulfadiazine, Sulfadoxine, Sulfamethoxazole, Sisomicin, Streptomycin, Sulfamethoxazole, Sulfisoxazole, Synercid (Quinupristan-Dalfopristan combination), Teicoplanin, Telithromycin, Temocillin, Tetracycline, Tetroxoprim, Thiamphenicol, Ticarcillin, Tigecycline, Tobramycin, Tosufloxacin, Trimethoprim, Trimetrexate, Trovafloxacin, Vancomycin, and Verdamicin.

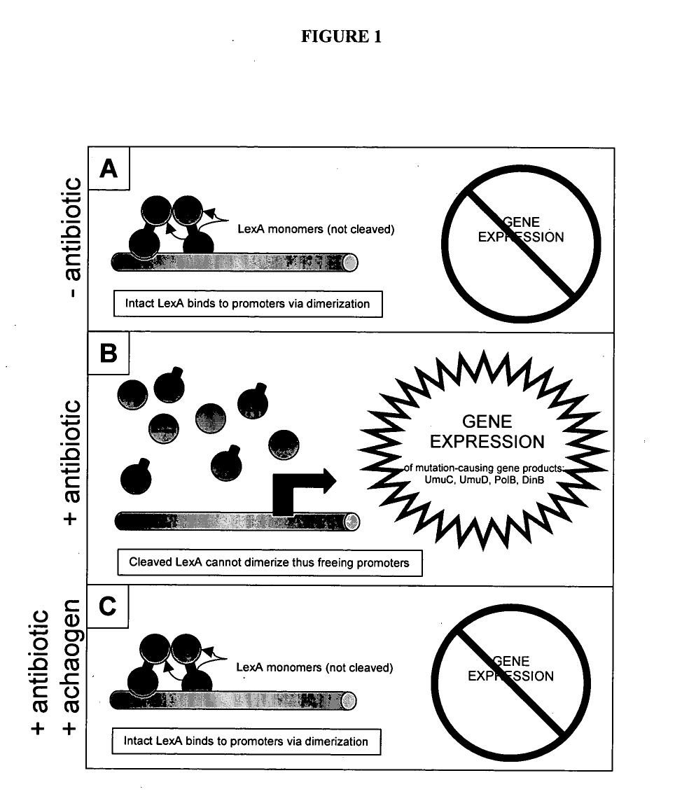

FIG. 1 depicts the cellular function of LexA under normal conditions and under the condition of cellular stress. Under normal conditions (FIG. 1A), LexA represses genes whose corresponding protein products are involved in the cellular response to stress (collectively referred to as the SOS response). See Goodman, M F: Error-prone repair DNA polymerases in prokaryotes and eukaryotes. Annu Rev Biochem 2002, 71:17-50; Nickoloff, J A, Hoekstra, M F (eds.) DNA Damage and Repair (Humana Press, Totowa, N.J., 1998). LexA monomers are bound to DNA, stabilized via interactions between the LexA dimerization domains. The binding of LexA dimers to their cognate binding sites prevents access of RNA polymerase to LexA-controlled promoters, keeping the intracellular concentrations of SOS response gene products low.

FIG. 1B shows what happens when bacteria are exposed to certain antibiotics (e.g., ciprofloxacin or rifampin). See Mamber, S W, Kolek, B, Brookshire, K W, Bonner, D P, Fungtomc, J: Activity of quinolones in the Ames Salmonella-TA102 mutageneicity test and other bacterial genotoxicity assays. Antimicrob Agents Chemother 1993, 37:213-217; Riesenfeld, C, Everett, M, Piddock, L J V, Hall, B G: Adaptive mutations produce resistance to ciprofloxacin. Antimicrob Agents Chemother 1997, 41:2059-2060; Phillips, I, Culebras, E, Moreno, F, Baquero, F: Induction of the SOS response by new 4-quinolones. J Antimicrob Chemother 1987, 20:631-638; Luo, Y, Pfuetzner, R A, Mosimann, S, Paetzel, M, Frey, E A, Cherney, M, Kim, B, Little, J W, Strynadka, N C J: Crystal structure of LexA: a conformational switch for regulation of self-cleavage. Cell 2001, 106:585-594; Shinagawa, H, Iwasaki, H, Kato, T, Nakata, A: RecA protein-dependent cleavage of UmuD protein and SOS mutagenesis. Proc Natl Acad Sci USA 1988, 85:1806-1810; Rehrauer, W M, Layery, P E, Palmer, E L, Singh, R N, Kowalczykowski, S C: Interaction of Escherichia coli RecA protein with LexA repressor. J Biol Chem 1996, 271:23865-23873; and Balashov, S, Humayun, M Z: Mistranslation induced by Streptomycin provokes a RecABC/RuvABC-dependent mutator phenotype in Escherichia coli cells. J Mol Biol 2002, 315:513-527. Such exposure activates the SOS response via the single-stranded-DNA-mediated activation of RecA (a bacterial protein involved in recombination and initiating the SOS response), which in turn catalyzes the autoproteolysis of LexA, resulting in the separation of LexA into its N and C terminal domains. After the proteolytic separation of its DNA binding and dimerization domains, LexA no longer efficiently binds DNA to repress gene expression. As a result SOS gene products are produced, including the mutation-causing gene products PolII, PolIV, and PolV (encoded by the genes PolB, DinB, and UmuDC, respectively). These gene products and these genes have different nominative designations in other organisms. The de-repression and subsequent transient expression of these gene products produces PolIV (a product of the DinB gene) and Poly (composed of a heterodimer of the product of the UmuC gene and two copies of UmuD′, a product of the RecA-mediated cleavage of UmuD), both mutation-causing polymerases. It is the de-repression of these polymerases, which synthesize DNA with low fidelity that is responsible for the increased rates of mutation at times of stress. It is proposed herein that the inhibition of this mutation inhibits the evolution of antibiotic resistance. See Yeiser, B, Pepper, E D, Goodman, M F, Finkel, S E: SOS-induced DNA polymerases enhance long-term survival and evolutionary fitness. Proc Natl Acad Sci USA 2002, 99:8737-3841; McKenzie, G J, Harris, R S, Lee, P L, Rosenberg, S M: The SOS response regulates adaptive mutation. Proc Natl Acad Sci USA 2000, 97:6646-6651; Goodman, M F, Tippin, B: Sloppier copier DNA polymerases involved in genome repair. Curr Opin Genet Dev 2000, 10:162-168; Shinagawa, H. in Stress-Inducible Cellular Responses (eds. Feige, U., Morimoto, R. I., Yahara, I. & Polla, B.) Birkh\check{S}user Verlag, Basel, 1996; Sutton, M D, Smith, B T, Godoy, V G, Walker, G C: The SOS response: recent insights into umuDC-dependent mutagenesis and DNA damage tolerance. Annu Rev Genet 2000, 34:479-497; Brotcome-Lannoye, A, Maenhaut-Michel, G: Role of RecA protein in untargeted UV mutagenesis of bacteriophage lambda: evidence for the requirement for the dinB gene. Proc Natl Acad Sci USA 1986, 83:3904-3908; Bull, H J, McKenzie, G J, Hastings, P J, Rosenberg, S M: Evidence that stationary phase hypermutation in the Escherichia coli chromosome is promoted by recombination. Genetics 2000, 154:1427-1437; Bull, H J, Lombardo, M J, Rosenberg, S M: Stationary-phase mutation in the bacterial chromosome: recombination protein and DNA polymerase IV dependence. Proc Natl Acad Sci USA 2001, 98:8334-8341; Kim, B, Little, J W: LexA and lambda CI repressors as enzymes: specific cleavage in an intramolecular reaction. Cell 1993, 73:1165-1173; Napolitano, R, Janel-Bintz, R, Wagner, J, Fuchs, RPP: All three SOS-inducible DNA polymerases (Pol II, Pol IV and Pol V) are involved in induced mutagenesis. EMBO 2000, 19:6259-6265; Tang, M, Pham, P, Shen, X, Taylor, JS, O'Donnell, M, Woodgate, R, Goodman, MF: Roles of E. coli DNA polymerase IV and V in lesion-targeted and untargeted SOS mutagenesis. Nature 2000, 404:1014-1018; and Prakash, S, Prakash, L: Translesion DNA synthesis in eukaryotes: a one- or two-polymerase affair. Genes Dev 2002, 16:1872-1883.

FIG. 1C shows what happens if an achaogen prevents LexA cleavage. In this scenario, the achaogen prevents the proteolysis of LexA, despite the presence of the antibiotic. As a result, the bacteria are not able to accelerate their rate of mutation, significantly slowing their ability to evolve antibiotic resistance. Inhibition of mutation with an achaogen can be achieved via multiple strategies, including (1) the inhibition of RecA (or any RecA ortholog) activation (2) the inhibition of RecA (or any RecA ortholog) binding to LexA or UmuD (or any LexA or UmuD ortholog) or any other yet to be identified component of the induced mutational response, and (3) the inhibition of LexA or UmuD (or any LexA or UmuD ortholog) proteolysis with small molecules.

Inhibition of RecA 's Activation of LexA Proteolysis and UmuD Proteolysis

In E. coli RecA is activated by the presence of single stranded DNA. Activated RecA binds to and activates the proteolysis of LexA and UmuD. See Goodman, M F: Error-prone repair DNA polymerases in prokaryotes and eukaryotes. Annu Rev Biochem 2002, 71:17-50; Nickoloff, J A, Hoekstra, M F (eds.) DNA Damage and Repair (Humana Press, Totowa, N.J., 1998). These events induce mutation via the de-repression of SOS gene products (resulting from LexA cleavage) and via the formation of E. coli Polymerase V (due to UmuD cleavage, a processing step required for Polymerase V (PolV) formation). See Goodman, M F: Error-prone repair DNA polymerases in prokaryotes and eukaryotes. Annu Rev Biochem 2002, 71:17-50; Nickoloff, J A, Hoekstra, M F (eds.) DNA Damage and Repair (Humana Press, Totowa, N.J., 1998).

One embodiment of the invention is a method of inhibiting antibiotic resistance by inhibiting the activation of RecA. Inhibition of the ability of RecA to bind single stranded DNA is used to inhibit antibiotic resistance.

Another embodiment of the invention is a method that inhibits the interaction between RecA and LexA or inhibits the interaction between RecA and UmuD to prevent the induction of mutations and thus inhibit the evolution of antibiotic resistance.

PsiB, for example, is able to compete with both LexA and UmuD for binding to RecA, while DinI competes only with UmuD. See Yasuda, T, Morimatsu, K, Horii, T, Nagata, T, Ohmori, H: Inhibition of Escherichia coli RecA coprotease activities by DinI. EMBO J. 1998, 17:3207-3216; Yasuda, T, Morimatsu, K, Kato, R, Usukura, J, Takahashi, M, Ohmori, H: Physical interactions between DinI and RecA nucleoprotein filament for the regulation of SOS mutagenesis. EMBO 2001, 20:1192-1202; and Bagadasarian, M, Bailone, A, Angulo, J F, Scholz, P, Bagdasarian, M, Devoret, R: PsiB, an anti-SOS protein, is transiently expressed by the F sex factor during its transmission to an Escherichia coli K-12 recipient. Mol Microbiol 1992, 6:885-893. In another embodiment of the invention, PsiB, DinI, their naturally-occurring or artificially-constructed variants, or agents that mimic the activity of PsiB and/or DinI can be used to inhibit mutagenesis and thus prevent the development of antibiotic resistance. While not all bacterial species possess PsiB and DinI genes and gene products, derivatives of these can still be used to inhibit induced mutagenesis in such species due to the conservation of RecA structure and function.

Both LexA and UmuD are serine-lysine diad proteases that undergo proteolysis reactions that are critical for the induction of mutation. See Roland, K L, Little, J W: Reaction of LexA repressor with diisopropyl fluorophosphate. J Biol Chem 1990, 265:12828-12835; Little, J W: LexA cleavage and other self-processing reactions. J Bacteriol 1993, 175:4943-4950; Kim, B, Little, J W: LexA and lambda CI repressors as enzymes: specific cleavage in an intramolecular reaction. Cell 1993, 73:1165-1173; and Slilaty, S N, Vu, H K: The role of electrostatic interactions in the mechanism of peptide bond hydrolysis by a Ser-Lys catalytic dyad. Prot Engineer 1991, 4:919-922. Another embodiment of the invention is a method that blocks the ability of LexA and/or UmuD to undergo proteolysis, such as via the use of covalent or non-covalent-protease inhibitors. The development of such inhibitors against proteases similar to LexA and UmuD has been accomplished using established drug design methods. See Vacca, J P: Thrombosis and coagulation. Annu Rep Med Chem 1998, 33:81-90; Verstraete, M: Modulating platelet function with selective thrombin inhibitors. Haemostasis 1996, 26 Suppl 4: 70-77; Morishima, Y, Tanabe, K, Terada, Y, Hara, T, Kunitada, S: Antithrombotic and hemorrhagic effects of DX-9065a, a direct and selective factor Xa inhibitor: comparison with a direct thrombin inhibitor and antithrombin III-dependent anticoagulants. Thromb Haemost 1997, 78:1366-1371; Edwards, P D, Bernstein, P R: Synthetic inhibitors of elastase. Med Res Rev 1994, 14(2): 127-94; Rice, K D, Tanaka, R D, Katz, B A, Numerof, R P, Moore, W R: Inhibitors of tryptase for the treatment of mast cell-mediated diseases. Curr Pharm Des 1998, 4:381-396; Oda, M, Ino, Y, Nakamura, K, Kuramoto, S, Shimamura, K, Iwaki, M, Fujii, S: Pharmacological studies on 6-amidino-2-naphthyl[4-(4,5-dihydro-1H-imidazol-2yl)amino]benzoatedimethane sulfonate (FUT-187). Jpn J Pharmacol 1990, 52:23-34; Steinkuhler, C, Biasiol, G, Brunetti, M, Urbani, A, Koch, U, Cortese, R, Pessi, A: Product inhibition of the hepatitis C virus NS3 protease. Biochemistry 1998, 37:8899-8905; Llinas-Brunet, M, Bailey, M, Fazal, G, Goulet, S, Halmos, T, Laplante, S, Maurice, R, Poirier, M, Poupart, M A, Thibeault, D et al.: Peptide-based inhibitors of the hepatitis C virus serine protease. Bioorg Med Chem Lett 1998, 8:1713-1718; and Boger, DL, Miyauchi, H, Hedrick, MP: a-Ketoheterocycle inhibitors of fatty acid amide hydrolase: carbonyl group modification and -substitution. Bioorg Med Chem Lett2001, 11:1517-1520.

Another embodiment is a method for inhibiting antibiotic resistance by stabilizing LexA and/or UmuD in conformations inappropriate for proteolysis.

Inhibition of Mutation-Causing Polymerases

The evolution of antibiotic resistance can also be prevented via the inhibition of the production, regulation, or function of the inducible, non-replicative, mutation-causing polymerases. Such polymerases include PolIV and Poly in E. coli or their functional analogs in other bacterial species, thus forcing the bacterium to use an ‘error free’ means of re-initiating DNA replication at a stalled replication fork. Methods that force the bacterium to use the ‘error free’ replication pathways would reduce mutability and thus disfavor the evolution of antibiotic resistance. In E. coli inactivation of either PolIV or Poly via gene disruption has been shown to result in a significant decrease in induced mutability due to ciprofloxacin or rifampin exposure.

Inactivation of a single mutation-causing polymerase in E. coli weakens the induced mutational response required for the evolution of antibiotic resistance. See Boshoff, H I M, Reed, M B, Barry, C E, Miizrahi, V: DnaE2 polymerase contributes to in vivo survival and the emergence of drug resistance in Mycobacterium tuberculosis. Cell 2003, 113:183-193. However, other mutation-causing polymerases continue to function to facilitate resistance. Hence, in a preferred embodiment, the function of many or all mutation-causing polymerases are modulated simultaneously, either by inhibiting their production (at the level of gene regulation as described above for the inhibition of LexA proteolysis) or their function (at the level of polymerase enzymatic activity). Due to the relaxed selectivity within the mutation-causing polymerase active sites, these enzymes will recognize nucleoside analogs not recognized by the replicative polymerases. Therefore, nucleoside analogs (e.g., dideoxy nucleosides with modified nucleobases or sugar rings) selectively inhibit these mutation-causing polymerases while not inhibiting higher fidelity polymerases. In one embodiment, a single inhibitor that inhibits multiple mutation-causing polymerases can be used, resulting in a far stronger suppression of induced mutation than could be achieved via the inhibition of a single polymerase.

Screening Assays for Identifying Achaogens and Drug Targets

Screens for Identifying Drug Targets

If a gene product is involved in induced mutation, its function results in an increase in a cell's ability to mutate. Inactivation of that gene product will decrease a cell's ability to mutate. These principles are used to determine if a given gene product is indeed mutation-causing and thus a potential drug target, the inhibition of which would suppress induced mutation and the development of antibiotic resistance.

In one embodiment, a test gene is genetically inactivated using known gene disruption techniques. After such a disruption event, the locus that encoded the putatively mutation-causing target would now be unable to produce the gene product and the cell would lack the function of that gene product. Various known ‘mutability’ assays are used to assess the effect of the gene disruption event on a cell's mutability. See Friedberg, E C, Walker, G C, Siede, W. DNA Repair and Mutagenesis (ed. Friedberg, E. C.) American Society of Microbiology, Washington D.C., 1995. For example, a Stressful Lifestyle Associated Mutation (SLAM) assay (as described in example #2 below wherein the evolution of resistance to an antibiotic of choice is measured) or a forward mutation or reversion assay can be used. See Bull, H J, Lombardo, M J, Rosenberg, S M: Stationary-phase mutation in the bacterial chromosome: recombination protein and DNA polymerase IV dependence. Proc Natl Acad Sci USA 2001, 98:8334-8341; Friedberg, E C, Walker, G C, Siede, W. DNA Repair and Mutagenesis (ed. Friedberg, E. C.) American Society of Microbiology, Washington D.C., 1995; Crouse, G F: Mutagenesis Assays in Yeast. Methods 2000, 22:116-119; Rosenberg, S M: Evolving responsively: adaptive mutation. Nature Rev Genet 2001, 2:504-515; Rosche, W A, Foster, P L: Determining mutation rates in bacterial populations. Methods 2000, 20:4-17; and Foster, P L: Adaptive mutation: implications for revolution. BioEssays 2000, 22:1067-1074.

In another embodiment, a bacterial strain with an inactivated test gene and a non-functional marker gene is used. Examples of marker genes that can be used include the LacZ gene, Green Fluorescent Protein gene, Red Fluorescent Protein gene, and Yellow Fluorescent Protein gene. The frequency at which the marker gene is made functional in the presence of a wild-type test gene and an inactivated test gene is determined. A decrease in the frequency in the presence of the inactivated test gene indicates the mutation-causing activity of the test gene.

In yet another embodiment, bacterial cells with an inactivated test gene or a wild-type test gene are exposed to an antibiotic. The number of cells that develop resistance to the antibiotic is quantified in both cells with the inactive test gene and cells with the wild-type test gene. A decrease in the number of cells that develop antibiotic resistance in the presence of the inactive test gene indicates that the test has potential mutation-causing activity.

Numerous techniques are known in the art to inactivate genes, which can be used to inactivate a test gene of interest. These techniques include the direct inactivation of the test gene, for example via mutation of the test gene. Another useful technique is the indirect activation of the test gene, for example via mutation of a gene whose gene product modulates the activity of the test gene.

Typically, the test gene is inactivated via one or more mutations such that the resulting peptide encoded by the test gene is inactive. Mutation of the test gene may be carried out using numerous mutagenesis techniques known in the art. At the genetic level, the mutants ordinarily are prepared by site-directed mutagenesis of nucleotides in the DNA. The mutants can be substitution mutants, deletion mutants, or insertion mutants.

Screens for Inhibitors of Mutation

Achaogens decrease the rate at which a cell mutates. This decreased mutability can be used as the basis for in vivo or in vitro assays to test collections of small molecules (i.e., small molecule libraries) to find a library member that affects the rate at which a bacterium mutates. This approach measures a compound's ability to inhibit mutability and does not presume any foreknowledge as to mechanism of action.

In one embodiment, a chemical collection of compounds is screened in a format similar to the SLAM assay (from example #2 below) to identify molecules that decrease mutability. Bacterial cells are exposed to either one test compound or a library of compounds and the number of mutant cells generated over a period of time is determined in the presence and absence of the test compound. A decrease in the number of mutant cells generated indicates the achaogenic activity of the test compound. The number of mutant cells generated is determined in either the growth phase or non-growth phase of the bacterial cells. The number of mutant cells is quantified using known assays, for example forward mutation or reversion assays. See Friedberg, E C, Walker, G C, Siede, W. DNA Repair and Mutagenesis (ed. Friedberg, E. C.) (American Society of Microbiology, Washington D.C., 1995); Crouse, G F: Mutagenesis Assays in Yeast. Methods 2000, 22:116-119.

In another embodiment, the number of mutant cells is determined in the presence of an antibiotic. That is, the bacterial cells and an antibiotic are exposed to the test compound, following which the number of mutant cells are quantified.

In yet another embodiment, the bacterial cells are exposed to a mutation-causing environment and the number of mutant cells generated is quantified in the presence and absence of the test compound. For example, a variation of the SLAM assay, described below, is used to proactively stress the bacteria (for example via exposure to UV radiation or chemical mutagens) so as to elevate mutation rates in bacteria. Such stress aids in the detection of achaogens due to the increased frequency of bacterial mutations.

In Vitro Target-Based Screening for Inhibitors of Mutation-Causing Gene Products LexA Cleavage Assay

Purified LexA protein, purified RecA protein, and single-stranded DNA are exposed to test compounds. In the presence of single-stranded DNA, RecA is activated and binds to LexA to catalyze LexA's cleavage reaction. In the presence of an achaogen, the activation of RecA, its binding to LexA, or LexA's cleavage reaction will be inhibited. The decreased activation of RecA, the decreased binding of RecA to LexA, or the direct chemical inhibition of LexA's cleavage reaction can be evaluated by determining the cleavage of LexA (e.g., by gel mobility assay, chromogenic assay, mass spectrometry, etc.). The inhibition of LexA cleavage indicates that the test compound is a potential achaogen.

A similar assay is run with the purified UmuD gene product in order to find inhibitors of its cleavage that thus prevent production of poly.

Polymerase Inhibition Assays

The inhibition of different mutation-causing polymerases by potential achaogens can be quantified using standard methods. See Ogawa, A K, Wu, Y Q, McMinn, D L, Liu, J Q, Schultz, P G, Romesberg, F E: Efforts toward the expansion of the genetic alphabet: Information storage and replication with unnatural hydrophobic base pairs. J Am Chem Soc 2000, 122:3274-3287. For example, the rate of DNA synthesis with a given polymerase may be measured in the presence and absence of the potential achaogen using 5′-radiolabeled oligonucleotide primers resolved after the reaction by polyacrylamide gel electrophoresis and quantification by standard methods. Alternatively, high-throughput assays can be used to screen through large compound libraries to identify potential achaogens. Such assays rely on arraying the reaction mixtures in 96-well plates, where each well also contains a different achaogen. Fluorophore labeled nucleoside triphosphates or oligonucleotide primers or templates can be used in conjunction with standard plate handling and visualization procedures to determine which molecules effectively inhibited the activity of a given polymerase. In one embodiment, libraries can be screened in the presence of one or more of the inducible polymerases in order to identify achaogens that would most efficiently prevent mutation by simultaneously inhibiting multiple polymerases (for example, pol IV and pol V in E. coli).

Strategies for Developing Achaogens

Achaogens can be small molecules, peptides, antibodies, or macromolecules (including DNA, RNA, proteins, or modified version of these macromolecules).

In one embodiment, the achaogen inactivates a mutation-causing gene or inactivates the protein encoded by the mutation-causing gene. For example, the achaogens can inactivate genes or gene products of E. coli genes PolB DinB UmuDC, RecA, or LexA or their functionally or structurally homologous genes and gene products in other bacteria.

In another embodiment, the achaogen mimics that activity of a gene or gene product that inhibits the mutational process. For example, the achaogen is PsiB or DinI or a peptide variant thereof. Preferably, the achaogen mimics the activity of PsiB and/or DinI.

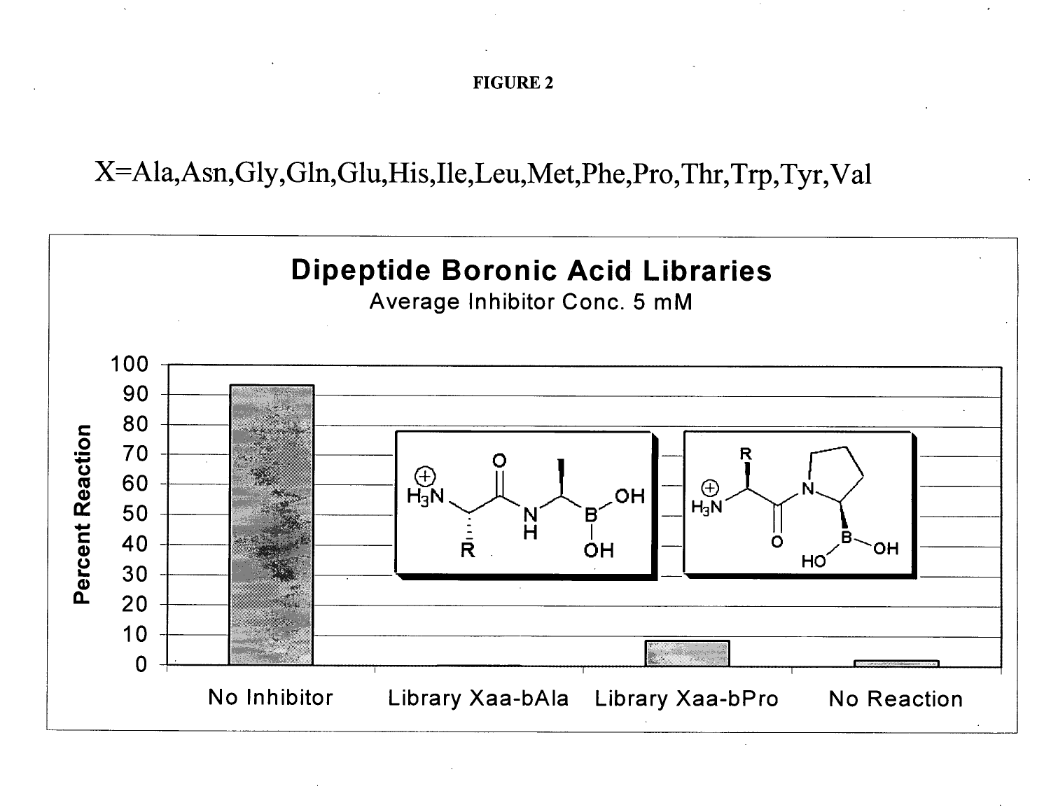

In yet another embodiment, the achaogens are identified from screening large libraries of chemical compounds, for example, boronic acid peptide derivatives. Boronic acid peptide derivatives useful in the present invention are described in FIGS. 2-5 and Example 4. Suitable boronic acid peptide derivates include dipeptide boronic acid derivatives, for example boronic alanine dipeptides and boronic proline dipeptides. Suitable acetylated dipeptide boronic acids include acetylated-valine-boro-ethylglycine, acetylated-valine-boro-alanine, and acetylated-lactam-boro-alanine. Suitable tripeptide boronic acid derivatives include acetylated-valine-alanine-boro-alanine, leucine-alanine-boro-alanine, acetylated-tert-bug-alanine-boro-alanine, and acetylated-chg-alanine-boro-alanine.

Boronic acid peptide derivatives can be synthesized using techniques known in the art. Examples of suitable techniques include those disclosed in Bachovchin, W W, Plaut, A G, Flentke, G R, Lynch, M, Kettner, C A: Inhibition of IgA1 proteinases from Neisseria gonorrhoeae and Hemophilus influenzae by peptide prolyl boronic acids. J Biol Chem 1990, 265:3738-3743.

The achaogens of the present invention also include antibodies or fragments of antibodies. Preferably, the antibodies bind and inactivate mutation-causing proteins, i.e., act as antagonists of mutation-causing proteins, to inhibit the development of drug resistance. The antibodies useful herein include whole antibodies, single-chain antibodies, and antigen-binding fragments thereof. Preferably the antibodies include, but are not limited to, Fab, Fab′ and F(ab′)₂, Fd, single-chain Fvs (scFv), single-chain antibodies, disulfide-linked Fvs (sdFv) and fragments comprising either a VL or VH domain. The antibodies may be from any animal origin including birds and mammals. Preferably, the antibodies are human, murine, rabbit, goat, guinea pig, camel, horse, or chicken. The antibodies useful in the present invention may be prepared by any suitable method known in the art.

In another embodiment of the invention, the achaogens are proteins, peptides, or peptide mimics of PsiB, DinI, or yet to be discovered proteins that modulate the mutagenic response. The protein or peptide achaogens might be developed from fragments of the respective proteins or fragments modified for increased affinity for their target protein (for example, RecA or LexA in E. coli) by rational design or library-based selections (for example, phage display or high-throughput screening). Achaogen peptide mimics might be designed based on the amino acid sequence of appropriate proteins or peptide fragments, modified for improved function, including improved target binding (for example, RecA or LexA in E. coli) or improved pharmacokinetics (for example, improved stability, cell permeability, or target specificity).

In addition, peptide mimics might be based on the known cleavage sequences of LexA and UmuD, or their functionally or structurally homologous proteins in other bacteria. This strategy is based on identifying the natural substrate sequence (highly conserved in the bacterial kingdom), truncating the sequence to short polypeptide (˜10 amino acids), replacing the cleavable bond with a noncleavable isostere, and optimizing potency through structural modifications that progressively reduce the peptide nature of the molecule and increase binding. Replacement groups (isosters) that have received widespread use for serine protease and serine-protease-like inhibitors include keto, trans-olefin, reduced amide, α-keto, and heterocyclic moieties. See Boger, D L, Miyauchi, H, Hedrick, M P: α-Ketoheterocycle inhibitors of fatty acid amide hydrolase: carbonyl group modification and α-substitution. Bioorg Med Chem Lett 2001, 11:1517-1520; Gringauz, A. Introduction to Medicinal Chemistry (Wiley-VCH, New York, 1997); and Leung, D, Abbenante, G, Fairlie, DP: Protease inhibitors: Current status and future prospects. J Med Chem2000, 43:305-341. This strategy has been used successfully to develop drugs that that inhibit related serine-like proteases, for example, thrombin [Vacca, J P: Thrombosis and coagulation. Annu Rep Med Chem 1998, 33:81-90; Verstraete, M: Modulating platelet function with selective thrombin inhibitors. Haemostasis 1996, 26 Suppl 4: 70-7]; factor Xa [Morishima, Y, Tanabe, K, Terada, Y, Hara, T, Kunitada, S: Antithrombotic and hemorrhagic effects of DX-9065a, a direct and selective factor Xa inhibitor: comparison with a direct thrombin inhibitor and antithrombin III-dependent anticoagulants. Thromb Haemost 1997, 78:1366-1371], elastase [Edwards, P D, Bernstein, P R: Synthetic inhibitors of elastase. Med Res Rev 1994, 14(2) 127-94], tryptase [Rice, K D, Tanaka, R D, Katz, B A, Numerof, R P, Moore, W R: Inhibitors of tryptase for the treatment of mast cell-mediated diseases. Curr Pharm Des 1998, 4:381-396], complement convertase [Oda, M, Ino, Y, Nakamura, K, Kuramoto, S, Shimamura, K, Iwaki, M, Fujii, S: Pharmacological studies on 6-amidino-2-naphthyl[4-(4,5-dihydro-1H-imidazol-2yl)amino]benzoatedimethane sulfonate (FUT-187). Jpn J Pharmacol 1990, 52:23-34], hepatitis C-NS3 protease [Steinkuhler, C, Biasiol, G, Brunetti, M, Urbani, A, Koch, U, Cortese, R, Pessi, A: Product inhibition of the hepatitis C virus NS3 protease. Biochemistry 1998, 37:8899-8905; Llinas-Brunet, M, Bailey, M, Fazal, G, Goulet, S, Halmos, T, Laplante, S, Maurice, R, Poirier, M, Poupart, M A, Thibeault, D et al.: Peptide-based inhibitors of the hepatitis C virus serine protease. Bioorg Med Chem Lett 1998, 8:1713-1718], and fatty acid amide hydrolase [Boger, DL, Miyauchi, H, Hedrick, MP. □-Ketoheterocycle inhibitors of fatty acid amide hydrolase: carbonyl group modification and substitution. Bioorg Med Chem Lett 2001, 11:1517-1520; Boger, D L, Sato, H, Lerner, A E, Hedrick, M P, Fecik, R A, Miyauchi, H, Wilkie, G D, Austin, B J, Patricelli, M P, Cravatt, B F: Exceptionally potent inhibitors of fatty acid amide hydrolase: the enzyme responsible for degradation of endogenous oleamide andanandamide. Proc Natl Acad Sci USA 2000, 97:5044-5049].

Inhibition of Drug Resistance

Achaogens inhibit the mutational process and thus are useful in preventing the development of drug resistance mediated by mutations. In particular, achaogens are useful to prevent bacteria from evolving resistance to an antibiotic. Achaogens are useful in preventing the development of resistance to antibiotics that lose their efficacy against bacteria due to the development of resistance caused by the mutational process.

In one embodiment of the invention an achaogen is administered to an animal to inhibit antibiotic resistance. In another embodiment, the achaogen is administered to an animal suffering from a bacterial infection. Preferably, the achaogen is co-administered with an antibiotic.

The achaogens of the present invention are also useful for inhibiting the development of drug resistance by inhibiting genetic mutations. In particular, achaogens can prevent the development of resistance to therapeutic agents that lose their efficacy due to the inducement of mutations, such as chemotherapeutic agents, antibiotics, and antivirals. The achaogens are used in combination with therapeutic agents in order to augment the beneficial effects of the therapeutic agent by inhibiting the mutational process. Alternatively, the achaogens can be used as a monotherapy to inhibit the mutational process.

In yet another embodiment, achaogens are used either as a monotherapy or combination therapy for the prevention and/or cure of diseases, like cancer, that are caused by the mutational process.

The term “animal” or “animal subject” as used herein includes humans as well as other mammals, birds, reptiles, amphibians, or fish. In one embodiment, the achaogen and antibiotic are co-administered. This co-administration can include simultaneous administration of the two agents in the same dosage form, simultaneous administration in separate dosage forms, or separate administration. That is, the achaogen and antibiotic can be formulated together in the same dosage form, or the achaogen and antibiotic can be simultaneously administered, wherein both the agents are present in separate formulations. In another alternative, the achaogen can be administered just followed by the antibiotic, or vice versa. In the separate administration protocol, the achaogen and antibiotic may be administered a few minutes apart, or a few hours apart, or a few days apart. Alternatively, the achaogen may be used prophylatically.

The term “treating” as used herein includes achieving a therapeutic benefit and/or a prophylactic benefit. Therapeutic benefit includes the eradication or amelioration of the underlying disorder being treated. For example, in a patient suffering from a bacterial infection, the therapeutic benefit includes eradication or amelioration of the underlying bacterial infection perhaps resulting from the prevention of the development of antibiotic resistance during the course of therapy. Also, a therapeutic benefit is achieved with the eradication or amelioration of one or more of the symptoms associated with the underlying disorder such that an improvement is observed in the patient, notwithstanding that the patient may still be afflicted with the underlying disorder. For example, co-administration of an achaogen and antibiotic to a patient suffering from a bacterial infection provides therapeutic benefit not only when the patient's serum load of bacteria is decreased, but also when an improvement is observed in the patient with respect to other symptoms that accompany a bacterial infection like fever, pain, and inflammation.

For prophylactic benefit, an achaogen and antibiotic may be co-administered to a patient at risk of developing a bacterial infection that could become antibiotic resistant or to a patient reporting one or more of the physiological symptoms of a bacterial infection, even though a diagnosis of a bacterial infection may not have been made.

Therapeutic and/or prophylactic benefit includes a beneficial effect in an individual patient and/or in a population of patients. Thus, although a therapeutic and/or prophylactic benefit is not observed in a particular individual, the achaogen is beneficial if it has an effect on a population of patients. The beneficial effect in a population of patients is particularly useful as it can reduce the level of antibiotic resistance in this population and thus increase the usefulness of antibiotics.

In addition, a therapeutic and/or prophylactic benefit can be achieved solely by a biological effect, i.e., an achaogenic effect, without an effect on the disease or the symptoms of the disease. An “achaogenic effect” is the inhibition of the mutational process in an organism.

The compositions of the present invention are suitable for inhibiting the development of drug resistance, in particular antibiotic resistance. Several techniques are known in the art for determining whether a particular strain of bacteria has developed resistance to an antibiotic. For example, if the administration of an antibiotic at a dose equivalent to its ED50 (the dose at which 50% of patients being treated respond) to a patient suffering from a bacterial infection does not result in a therapeutic benefit, the bacteria is considered to be resistant to the antibiotic. Preferably, the achaogen is co-administered with the antibiotic at a dose sufficient to prevent or inhibit the development of antibiotic resistance. The administration of the achaogen with the antibiotic causes the prevention or inhibition of antibiotic resistance and the bacterial infection in the patient is either ameliorated or eradicated.

Pharmaceutical compositions suitable for use in the present invention include compositions wherein the achaogen and/or antibiotic are present in an effective amount, i.e., in an amount effective to achieve therapeutic or prophylactic benefit. The actual amount effective for a particular application will depend on the condition being treated and the route of administration. Determination of an effective amount is well within the capabilities of those skilled in the art, especially in light of the disclosure herein.

The effective amount for use in humans can be determined from animal models. For example, a dose for humans can be formulated to achieve circulating concentrations that have been found to be effective in animals.

The effective amount when referring to the antibiotics will generally mean the dose ranges, modes of administration, formulations, etc., that have been recommended or approved by any of the various regulatory or advisory organizations in the medical or pharmaceutical arts (e.g., FDA, AMA) or by the manufacturer or supplier. Effective amounts of antibiotics can be found, for example, in the Physicians Desk Reference.

A skilled person using techniques known in the art can determine the effective amount of the achaogen. In one embodiment, the effective amount of achaogen co-administered with an antibiotic is the amount that prevents or inhibits the development of antibiotic resistance. Even a small inhibition in the development of antibiotic resistance is considered useful for the present invention. A statistically significant decrease in the development of antibiotic resistance is particularly preferred.

Achaogenesis, i.e., inhibition of the mutation process, can be achieved genetically by using a genetic means of inactivating a mutation-causing gene product. This would be useful for (1) determining what genes mediate mutation in a whole organism context or (2) assessing the effect of the loss of the ability to mutate on a whole organism. For example, such an engineered animal might be less susceptible to certain forms of cancer. Such an engineered animal can be created in which the germ line of the organism was modified using transgenic methods (e.g., either or both of the loci encoding the mutation-causing gene product is modified so as not to produce the mutation-causing gene product, or to produce a non mutation-causing version of the gene product). Alternatively, it has recently been demonstrated that RNAi techniques (a set of techniques in which cells are instructed to destroy RNAs of a particular sequence using double stranded RNA as a trigger) can be used during embryonic development to confer lifetime epigenetic changes to all of the cells of a mouse. See McManus, M T, Sharp, P A: Gene silencing in mammals by small interfering RNAs. Nature Rev 2002, 3:737747. The same approach could potentially be used for a variety of mammals.

The inducible mutagenesis pathways discussed herein are also known to exist in eukaryotic cells. Thus, achaogens can be used to inhibit the mutational process in eukaryotic cells. In one embodiment, achaogens are used as an adjuvant or supplement to therapies in human cells where therapeutic outcomes are compromised by mutations. These therapies include, but are not limited to chemotherapy. In another embodiment, an achaogen is used as a prophylactic to prevent mutations, for example to prevent tumorgenesis and carcinogenesis. The achaogens are suitable to prevent both benign and malignant tumors.

In addition to the therapeutic uses described above, the achaogens are useful in numerous industrial applications. In particular, the achaogens are useful in industrial processes that are hindered due to the development of mutations in the organisms used in the processes. Suitable applications include the prevention of mutations in yeast used in breweries and other biotechnology applications. Another suitable use is to prevent mutations in bacteria that are used for the synthesis of proteins, like antibodies, etc. Other suitable uses will be apparent to one of skill in the art based on the disclosure herein.

### EXAMPLES

The Examples below demonstrate that the administration of either ciprofloxacin or rifampin induces the mutational process. Also, the Examples demonstrate that the loss of function of certain gene products cripples the induced mutational process driving the evolution of antibiotic resistance.

### Example 1

To demonstrate that the administration of ciprofloxacin induces adaptive mutation we examined the evolution of resistance of wild type MG1655 E. coli on solid media plates containing 35 ng/mL ciprofloxacin. First we differentiated colonies that arouse during the exponential growth phase, prior to plating, and those that arouse after plating. This was done by isolating colonies, noting the day they appeared, and then regrowing the colonies and determining the time until a colony appears. For example, if a colony appeared on day three, but then required three days to re-grow, it is assumed to have obtained a resistance mutation during the exponential growth phase, prior to exposure to antibiotic. If a colony is isolated on day five, and then found to require only one day to re-grow, it is assumed to have mutated on day four, after exposure to the antibiotic.

Three observations were immediately apparent from inspection of the data. First, the number of mutations per viable cell per day increased by at least four-orders of magnitude after exposure to the antibiotic (similar to results reported earlier in Riesenfeld, C, Everett, M, Piddock, L J V, Hall, B G: Adaptive mutations produce resistance to ciprofloxacin. Antimicrob Agents Chemother 1997, 41:2059-2060). Second, the rates of mutation prior to drug exposure were virtually independent of the gene deletions described below in Example 2, whereas the mutation rate after drug exposure was strongly dependent (being both increased or reduced upon deletion of certain genes, see below). Finally, the type of mutation (base substitution versus deletion) that arouse before drug exposure was independent of gene deletion, whereas those that arouse after exposure to ciprofloxacin depended very strongly on gene deletion. This data implies that a mutational system is induced upon exposure to ciprofloxacin and that this system is both mechanistically unique and responsible for the majority of the mutations that give rise to ciprofloxacin resistance.

To further understand the effects of induced mutation resulting from exposure to antibiotics we determined whether or not pre-exposure to rifampicin, an unrelated antibiotic, could induce mutations that bestowed the bacteria with ciprofloxacin resistance. E. coli MG1655 were incubated in PBS containing 0, 4, 12, and 36 mg/mL rifampciin for four days at 37° C., and then plated on agar containing Luria Broth (LB) with 35 ng/mL ciprofloxacin. Incubation in the presence of zero or 4 mg/mL had no effect on the number of ciprofloxacin resistant colonies present in the culture. However, incubation in the presence of more rifampicin (12 or 36 mg/mL) resulted in a dramatic increase in the number of ciprofloxacin resistant cells. This effect was essentially completely lost in the UmuDC deletion stain, demonstrating that the resistance in the wild type strain results from induced mutation mediated by Poly. Apparently, pre-incubation with a suitable concentration of rifampicin induces the mutation system (for example, during repair synthesis), but since the cells are in stationary phase there is no clonal expansion and no selection of more fit mutants. Thus, mutations that impart resistance to ciprofloxacin are induced, maintained, and then selected for with ciprofloxacin.

### Example 2

To examine the evolution of resistance we have selected the E. coli strain MG1655 as the genetic background, as this K-12 strain was used in the genome sequencing project of E. coli. Strains listed in the accompanying Table 1 were constructed using PCR-mediated gene replacement. See Murphy, K C, Campellone, K G, Poteete, A R: PCR-mediated gene replacement in Escherchia coli. Gene 2000, 246:321-330. PCR reactions were performed using Platinum pfx DNA polymerase from Invitrogen, with standard cycling parameters. Genomic template DNA was prepared from a fresh bacterial overnight culture using the DNeasy kit (Qiagen).

The kanamycin cassette was PCR amplified from a pUC4K plasmid insertion using primers 5′-GGA AAG CCA CGT TGT GTC TC and 5′-CGA TTT ATT CAA CAA AGC CGC. Gene specific components from each gene were amplified from MG1655 genomic DNA to obtain two PCR products: the ‘N-fragment’ containing 500 base pairs upstream and including the first two to three codons and the ‘C-fragment’ containing the last two to three codons and 500 base pairs downstream. The fragment ends were engineered to contain the reverse complement of the kanamycin cassette sequence at their internal sites by using primers with 20 base pairs of homology and a 20 base pair tail complementary to the kanamycin cassette ends at the 3′-end for the N fragment and at the 5′-end for the C fragment.

TABLE 1
Table of strains used.

| Parent | Mutation |
|---|---|
| MG1655 | — |
| ATCC25922 | — |
| MG1655 | DY329 (nadA::RED) |
| MG1655 | lacZΔ::kan |
| MG1655 | polBΔ::kan |
| MG1655 | polBΔ::spc |
| MG1655 | dinBΔ::kan |
| MG1655 | umuDCΔ::kan |
| MG1655 | umuDCΔ::cat |
| MG1655 | polBΔ::Spc, dinBΔ::kan |
| MG1655 | polBΔ::Spc, umuDCΔ::kan |
| MG1655 | dinBΔ::kan umuDCΔ::cat |
| MG1655 | polBΔ::spc dinBΔ::kan, UmuDC::Cat |
| MG1655 | LexA(S119A)::kan |
| MG1655 | recAΔ::kan |
| MG1655 | recBΔ::kan |
| MG1655 | recDΔ::kan |
| MG1655 | recFΔ::kan |
| MG1655 | recGΔ::kan |
| MG1655 | ruvBΔ::kan |
| MG1655 | ruvCΔ::kan |
| MG1655 | sulAΔ::kan |
| MG1655 | priAΔ::kan |
| ATCC25922 | lacZΔ::kan |
| ATCC25922 | LexA(S119A)::kan |
| ATCC25922 | recFΔ::kan |

To create the full, gene-specific disruption cassettes, the products of the N-fragment, C-fragment and kanamycin cassette reactions were combined in a PCR reaction, in equal volume. Conditions for this PCR reaction were standard, with the exception that the proximal primers were used in limiting amounts. The excess distal primer is consumed in the second PCR reaction. The complementary sequences on the N- and C-fragments acted as primers for the kanamycin cassette, which resulted in a final product containing approximately 500 base pairs of upstream sequence, the kanamycin cassette in a reverse orientation to the gene that was knocked out, and 500 base pairs of downstream sequence.

Generation of the genomic deletions in MG1655 proceeded in two steps: (i) genomic insertion into strain MG-DY329 and (ii) P1-mediated transfer of the deletion cassette to MG1655. In the first step, the linear DNA fragments (PCR products) were electroporated into the hyper-recombinational E. coli strain MG-DY329 [Yu, D, Ellis, H M, Lee, E-C, Jenkins, N A, Copeland, N G, Court, D L: An efficient recombination system for chromosome engineering in Escherichia coli. Proc Natl Acad Sci USA2000, 97:5978-5983], a derivative of MG1655 which carries the lambda phage red genes. This strain accepted the linear PCR product and recombined it into the genome with high efficiency. Recombination genes were activated by growing DY329 at 42° C. and the competent cells stored at −80° C. The competent cells were transformed with the desired kanamycin cassette and kanR transformants selected at 30° C.

Although MG-DY329 was engineered such that the lambda phage red genes could be easily removed to return the cell to a non-hyper-recombinational background, we used P1 transduction to move the gene-specific disruption from MG-DY329 into MG1655. MG1655 provides a more ‘wild-type’ background than MG-DY329, and thus simplifies the interpretation of the results. Gene deletions were verified by PCR.

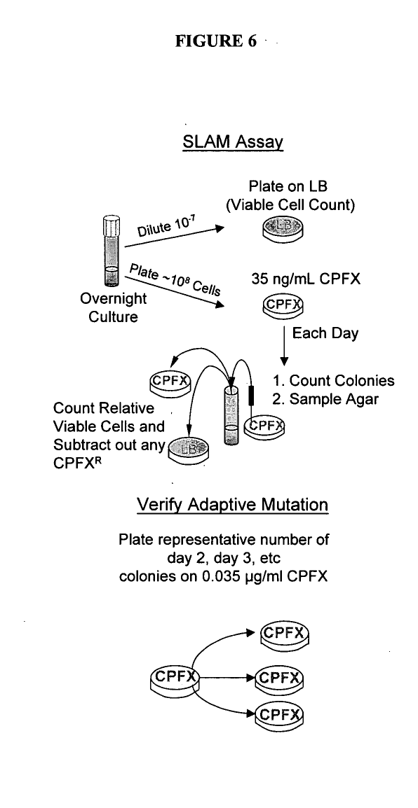

With the isogenic loss of function strains in hand, mutation in response to ciprofloxacin (obtained from USBiologicals) was determined using a protocol based on the Stressful Lifestyle Adaptive Mutation (SLAM) assay were performed as illustrated in FIG. 6. Five colonies of each strain, selected from 30 ug/mL kan plates, were grown for 24 hours in LB at 37° C. Dilutions of each culture were made in duplicate and plated on LB plates to determine the number of viable cells.

To assay for mutation, 150 μL of each culture was plated twice on LB plates containing 35 ng/mL ciprofloxacin. Also, two 150 μL cultures from each strain were plated on five additional plates for use in ‘survival’ experiments (see below). The concentration of ciprofloxacin used was chosen based on trial experiments with the MG1655 parent strain which indicated that 35 ng/mL ciprofloxacin maximized mutation-dependent growth. Every twenty-four hours for thirteen days post-plating, colonies were counted and marked and up to 10 representative colonies per strain were stocked in 15% glycerol and stored at −80° C., for use in the reconstruction experiments (see below). Also, to determine the number of ciprofloxacin susceptible cells remaining on the plates, parallel ‘survival’ experiments were performed. The ‘survival’ experiment plates were treated exactly as the SLAM plates, except at specified time points, representative plates were sacrificed by excising all visible colonies, recovering the remaining agar in 9 mg/mL saline, and plating dilutions of the resulting solution on LB and LB containing 35 ng/mL ciprofloxacin.

After thirteen days, a reconstruction experiment [see FIG. 6; also see Bull, H J, Lombardo, M J, Rosenberg, S M: Stationary-phase mutation in the bacterial chromosome: recombination protein and DNA polymerase IV dependence. Proc Natl Acad Sci USA 2001, 98:8334-8341; and Rosenberg, S M: Evolving responsively: adaptive mutation. Nature Rev Genet 2001, 2:504-515] was performed to determine which of the resistant colonies isolated had evolved resistance via adaptive mutation after exposure to the antibiotic. The stocked colony suspensions isolated during the original experiment were used to inoculate 1 mL of LB and grown overnight at 37° C. The resulting cultures were then diluted and duplicate plated on LB and LB containing 35 ng/mL ciprofloxacin and the time elapsed to colony formation was recorded and compared to the original experiment. Only those colonies that grew in a shorter time during the reconstruction experiment than in the original experiment were considered to have acquired an adaptive mutation, i.e. occurred after exposure to the antibiotic. Using the colony counts of adaptive mutants on the ciprofloxacin containing SLAM plates and the viable cell counts from the ‘survival’ experiments, an adaptive mutation rate was calculated per viable cell.

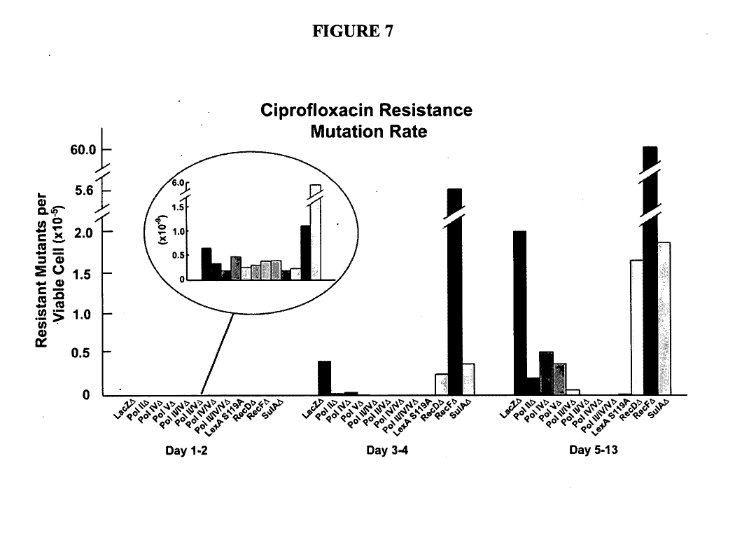

The data is shown in FIG. 7. Resistance was found to be significantly reduced in several strains, including PolBΔ (pol II deletion strain) DinBΔ (pol IV deletion strain), UmuDCΔ (pol V deletion stain), and LexA(Ind⁻) (which encodes an uninducable LexA S119A mutant). The largest effect from any single mutation was seen for the LexA(Ind⁻) strain which was more than two orders of magnitude less able to evolve resistance to ciprofloxacin (the precise amount depending on the antibiotic concentration). The observed effect is remarkably large when considered in the context of clinical resistance. Clincially relevant high resistance requires multiple independent mutations. See Drlica, K, Zhao, X: DNA Gyrase, topoisomerase IV, and the 4-quinolones. Microbiol Mol Biol Rev 1997, 61:377-392; Gibreel, A, Sj\check{s}gren, E, Kaijser, B, Wretlind, B, Sk\check{s}ld, O: Rapid emergence of high-level resistance to quinolones in Campylobacter jejuni associated with mutational changes in gyrA and parC. Antimicrob Agents Chemother 1998, 42:3276-3278; Kaatz, G W, Seo, S M, Ruble, C A: Efflux-mediated fluoroquinolone resistance in Staphylococcus aureus. Antimicrob Agents Chemother 1993, 37:1086-1094; Yoshida, H, Bogaki, M, Nakamura, S, Ubukata, K, Konno, M: Nucleotide-sequence and characterization of the Staphylococcus-aureus nora gene, which confers resistance to quinolones. J Bacteriol 1990, 172:6942-6949; Poole, K: Efflux-mediated resistance to fluoroquinolones in gram-negative bacteria. Antimicrob Agents Chemother 2000, 44:2233-2241; Kern, W V, Oethinger, M, Jellen-Ritter, A S, Levy, S B: Non-target gene mutations in the development of fluoroquinolone resistance in Escherichia coli. Antimicrob Agents Chemother 2000, 44:814-820; Fukuda, H, Hori, S, Hiramatsu, K: Antibacterial activity of gatifloxacin (AM-1155, CG5501, BMS-206584), a newly developed fluoroquinolone, against sequentially acquired quinolone-resistant mutants and the norA transformant of Staphylococcus aureus. Antimicrob Agents Chemother 1998,42:1917-1922, whereas resistance in these experiments requires a single mutation (in the gyrA gene, confirmed by sequencing). We have confirmed this by measuring the rate at which mutants selected in the above-described experiment (where 35 ng/mL of ciprofloxacin was used) evolved the ability to grow at 60 ng/mL ciprofloxacin. The LexA mutant showed a 300-fold decreased rate of evolution. It is therefore expected that an achaogen that efficiently inhibits LexA cleavage or the induction, activation, or function of the inducible polymerases, should achieve an up to six-order of magnitude reduction in the rate at which bacteria evolve drug resistance.

Sequencing the gyrA gene revealed an interesting pattern. In the wild type stain, adaptive mutants (arouse after day 4) showed an approximately ˜2:1 ratio of point mutation to codon deletion. Deletion of any of the three polymerases resulted in 100% codon deletion, implying a major mutational sub-branch that depends on the activity of all three polymerases is required for base substitution mutation. The codon deletion pathway, however, can function with any one of the induced mutation-causing polymerase genes deleted.

### Example 3

In vivo experiments were performed in mice to predict the effect on the emergence of drug resistance in an infection context with the cleavage of LexA effectively inhibited.

Infections were established in mice thigh muscle with one of the following two bacterial strains—an essentially wild type 25922 (a pathogenic strain of E. coli) where the LacZ gene was replaced with the kanr marker (as described above) or a variant of 25922 modified as described above to possess the LexA gene product was LexA(S119A) gene instead of LexA wild type gene. These strains are referred to as ‘LacZ’ and ‘LexA(S119A)’, respectively. We then administered ciprofloxacin to the mice at a drug dose that was approximately cytostatic. Mice were killed, their legs homogenized, total cell counts were taken from each thigh, and then the thighs were plated on ciprofloxacin containing plates to count ciprofloxacin resistance colonies. The data from this experiment is presented in Table 2.

TABLE 2
a. Colonies isolated on plates containing 20/80 ng/mL ciprofloxacin

| Days | | |
|---|---|---|
| post infection | LacZ | LexA(S119A) |
| 1 | 93/65 | 3/1 |
| 2 | 28/23 | 2/0 |

As can be seen from Table 2, very few ciprofloxacin resistant bacteria were observed in the mutant LexA strain compared to the wild type bacteria.

### Example 4

Modified peptides were tested for their ability to inhibit LexA proteolysis. To determine the ability of the modified peptide to inhibit LexA activity, the peptide was combined with purified, recombinant LexA, RecA, and single-stranded DNA. In the presence of RecA and single-stranded DNA, almost 100% of cleavage of LexA was observed in less than 20 minutes. If a decrease in the cleavage of LexA was observed in the presence of a particular modified peptide, the modified peptide was considered to have the ability to inhibit the activity of LexA.

FIG. 2 depicts the results obtained with two dipetide boronic acid libraries. Both librarires, the boronic proline dipeptide library and boronic alanine dipeptide library, significantly inhibited LexA cleavage.

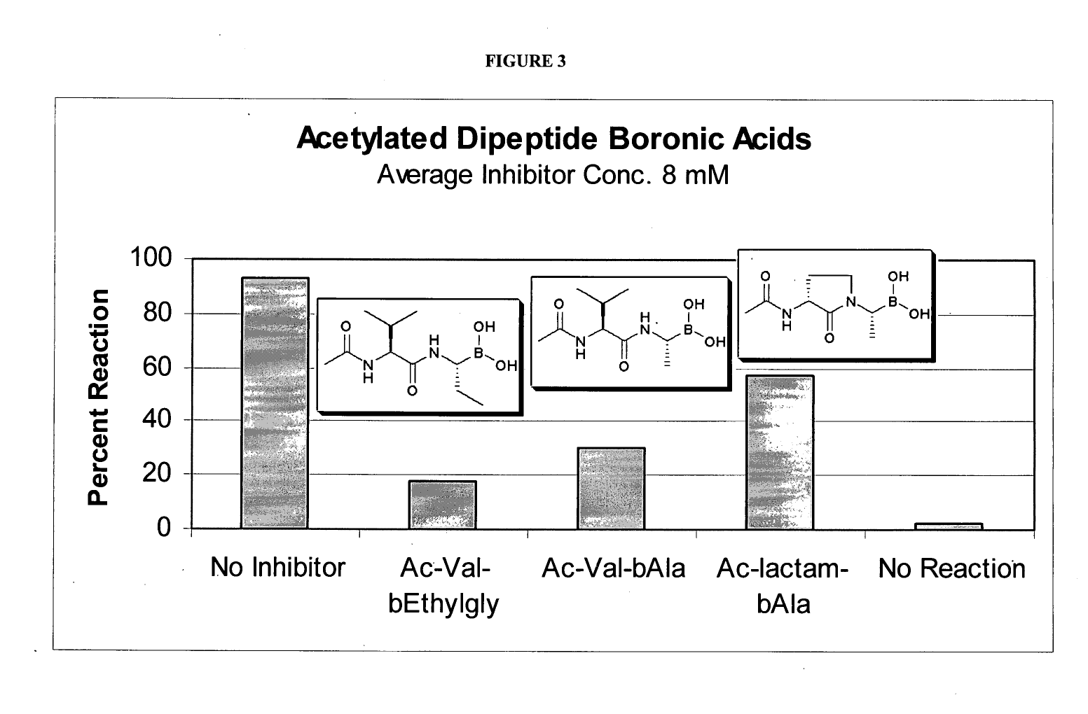

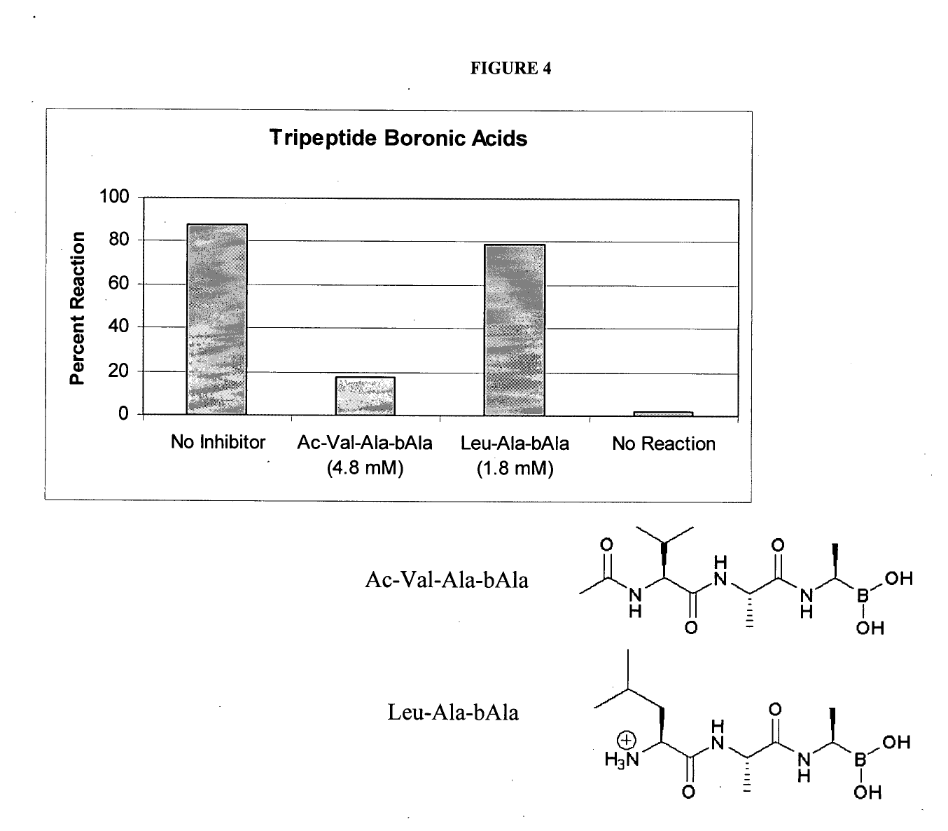

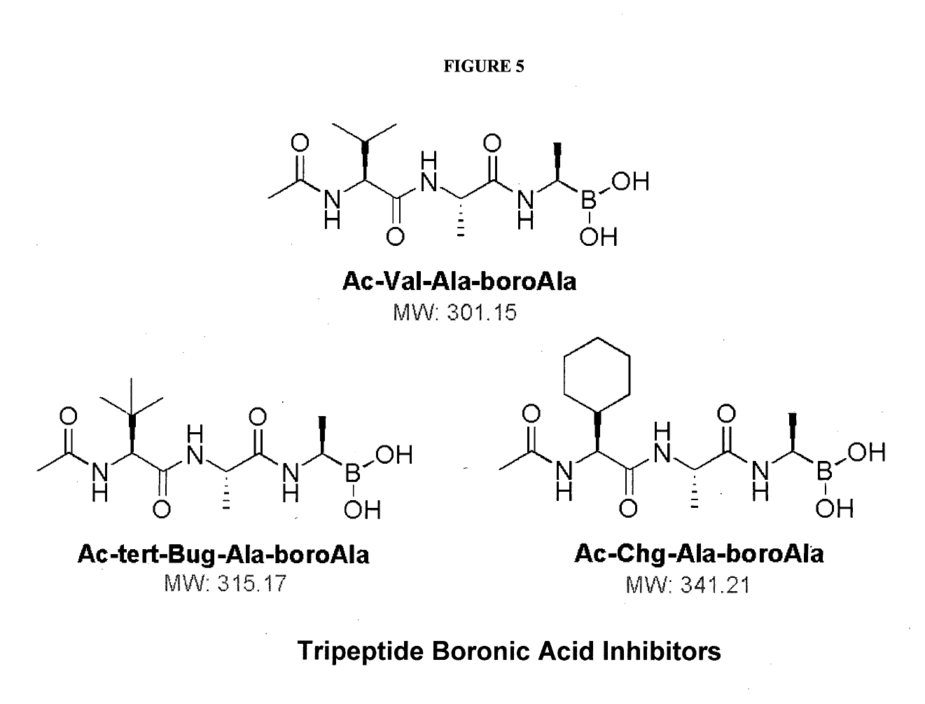

FIG. 3 depicts the results with acetylated dipeptide boronic acids, which also significantly inhibited LexA cleavage. FIGS. 4 and 5 show the structures of tripeptide boronic acid inhibitors and their effects on LexA cleavage.

All publications and patent applications mentioned in this specification are herein incorporated by reference to the same extent as if each individual publication or patent application was specifically and individually indicated to be incorporated by reference.

It will be apparent to one of ordinary skill in the art that many changes and modifications can be made thereto without departing from the spirit or scope of the appended claims.

1. A business method comprising:
identifying a compound that is effective as an antibiotic;
determining if bacteria develop resistance to said compound whereby said compound would have decreased market potential because of, at least in part, said resistance; and
selling said compound with an achaogen.

2. The method as recited in claim 1 further comprising the step of a biopharmaceutical company licensing rights from another organization to said compound.

3. The method as recited in claim 1 wherein said step of selling further comprises a biopharmaceutical company collecting royalties from a pharmaceutical company that that sells said achaogen with said compound.

4. The method as recited in claim 1 further comprising the step of collecting fees from a pharmaceutical company that sells said compound with said achaogen.

5. The method as recited in claim 4 wherein said fees comprise at least one of license fees and milestone fees.

6. The method as recited in claim 1 wherein a biopharmaceutical company performs experiments to identify said achaogen.

7. The method as recited in claim 6 wherein said biopharmaceutical company performs said experiments for a pharmaceutical company that has the right to sell said compound.

8. The method as recited in claim 7 wherein said pharmaceutical company pays research fees to said biopharmaceutical company.

9. The method as recited in claim 7 wherein said pharmaceutical company pays royalties to said biopharmaceutical company for sales of said compound.

10. The method as recited in claim 1 wherein
a biopharmaceutical company licenses or acquires said compound from a pharmaceutical company;
said biopharmaceutical company identifies said achaogen for use with said compound.

11. The method as recited in claim 1 or 10 wherein said biopharmaceutical company sells said achaogen and said compound.

12. The method as recited in claim 10 wherein said biopharmaceutical company licenses a selling company to sell said compound with said achaogen.

13. The method as recited 10 wherein said compound is a preclinical compound.

14. The method as recited in claim 10 wherein said compound is a compound in clinical trials at the time said biotechnology company licenses said a compound.

15. The method as recited in claim 10 wherein said compound is a marketed compound.

16. The method as recited in claim 1 wherein said compound is off patent.

17. The method as recited in claim 1 or 14 further comprising the step of patenting a new combination of an achaogen and said compound.

18. The method as recited in claim 10 wherein said biopharmaceutical company contracts for sale of said compound by a sales company.

19. The method as recited in claim 1 wherein
a biopharmaceutical company licenses said compound from a pharmaceutical company;
said biopharmaceutical company identifies said achaogen for use with said compound; and
said biopharmaceutical company licenses said pharmaceutical company to use said compound with said achaogen.

20. The method as recited in claim 6 further comprising the steps of
contacting a bacterial cells with the antibiotic and a test compound;
determining the number of mutations per bacterial cell in the presence of the test compound and antibiotic and the number of mutations per bacterial cell without said test compound; and
comparing the number of bacterial mutations in step b. wherein a decrease in the number of mutations in the presence of the test compound indicates achaogenic activity of the test compound.

21. The method of claim 1 wherein the achoagen modulates the activity of one or more genes selected from the group consisting of PolB, DinB, UmuDC, and LexA.

22. The method of claim 1 wherein the achoagen is an antibody or a fragments of said antibody, capable of binding to a protein encoded by a gene selected from the group consisting of PolB, DinB, UmuDC, and LexA. The method of claim 6, wherein the achoagen is a small molecule, capable of inactivating one or more genes selected from the group consisting of PolB, DinB, UmuDC, and LexA.

23. The method of claim 1 wherein the achoagen is a small molecule capable of binding to a protein encoded by a gene selected from the group consisting of PolB, DinB, UmuDC, and LexA.

24. The method as recited in claim 1 wherein said compound is off patent.

25. The method as recited in claim 1, 10, 19, or 24 further comprising the step of patenting use of said achaogen with said compound.
